(19) United States
(12) Patent Application Publication
(10) Pub. No.: US 2008/0101632 A1
(43) Pub. Date: May 1, 2008

(54) Wireless multi-channel audio system

(75) Inventors: Mu-Hsuan Lee, Chung Ho City (TW); Shen-Chin Chao, Chung Ho City (TW); Chung-Shih Chen, Chung Ho City (TW)

Correspondence Address: BIRCH STEWART KOLASCH & BIRCH, PO BOX 747, FALLS CHURCH, VA, 22040-0747, US

(73) Assignee: AmTRAN TECHNOLOGY CO., LTD.

(21) Appl. No.: 11/806,940

(22) Filed: Jun. 5, 2007

(30) Foreign Application Priority Data
Oct. 27, 2006 (TW) 095219060

(51) Int. Cl. H04S 3/00; G06F 17/00; H04R 5/00; H04R 5/02

(52) U.S. Cl. 381/307; 381/1; 381/300; 700/94

(57) ABSTRACT

A wireless multi-channel audio system is provided. The audio system includes a multiplexer, a transmitting antenna, a transmitter, and M playback apparatuses. First, the multiplexer receives M channels of audio signals and adds an ith identification to the ith channel of audio signals among the M channels of audio signals. Next, the multiplexer mixes the M channels of audio signals to generate a mixed signal in a time-division multiplexing way. After receiving the mixed signal from the multiplexer, the transmitter transmits the mixed signal through the transmitting antenna. The ith playback apparatus among the M playback apparatuses includes an ith antenna, an ith receiver, and an ith loudspeaker. The ith receiver receives the ith channel of audio signals from the mixed signal according to the ith identification and through the ith antenna. And, the ith loudspeaker plays back the ith channel of audio signal received by the ith receiver.

### BACKGROUND OF THE INVENTION

1. Field of the Invention

The invention relates to a multimedia system and, more particularly, to a multi-channel audio system.

2. Description of the Prior Art

In recent years, with the rapid development of various electronic products, multimedia systems, such as a home theater, have become more and more popular. In a multimedia system, except a monitor for displaying images, the most important hardware is a stereo. Taking a 5.1-channel stereo for example, it includes a left loudspeaker, a right loudspeaker, a middle loudspeaker, a left rear loudspeaker, a right rear loudspeaker, and a bass loudspeaker. And, if the loudspeakers are located at appropriate locations and directions, and each of the loudspeakers is allowed to playback different audio signal respectively, users will gain stereophonic sound effects.

In order to simplify the connecting lines among the loudspeakers, some stereo systems will wirelessly transmit a multi-channel audio signal. According to present wireless transmission protocols, the transmission end in the audio system can only transmit at most two channels of signals at the same time. Relatively, the reception end in the audio system can only receive at most two channels of signals at the same time. Thus, before being transmitted to the reception end, a multi-channel audio signal including more than two channels of audio signals must be integrated into a single decoded digital signal. For example, integrated Dolby decoded digital signal or integrated DTS decoded digital signal.

Referring to FIG. 1, FIG. 1 shows a multi-channel audio system according to the prior art. The multi-channel audio system includes a transmission end 10A and a reception end 10B. The transmission end 10A further includes a transmitter 11 and a transmitting antenna 12. The reception end 10B includes three playback apparatus, which are 13A, 13B, and 13C.

The transmitter 11 is used to receive an integrated audio signal and transmit the integrated signal to the playback apparatus 13A, 13B, and 13C via the transmitting antenna 12. In this embodiment, the integrated audio signal is integrated by three channels of audio signals which are a first channel audio signal, a second channel audio signal, and a third channel audio signal.

As shown in FIG. 1A, the playback apparatus 13A includes the first antenna 14A, the first receiver 15A, the first decoder 16A, and first loudspeaker 17A; the playback apparatus 13B includes the second antenna 14B, the second receiver 15B, the second decoder 16B, and second loudspeaker 17B; and the playback apparatus 13C includes the third antenna 14C, the third receiver 15C, the third decoder 16C, and third loudspeaker 17C.

First, the receivers of the playback apparatus 13A, 13B, and 13C receive the integrated audio signal transmitted by the transmission end 10A via the antenna 14A, 14B, and 14C respectively. Then, the first decoder 16A decodes the integrated audio signal to obtain the first channel audio signal; the second decoder 16B decodes the integrated audio signal to obtain the second channel audio signal; and the third decoder 16C decodes the integrated audio signal to obtain the third channel audio signal. Moreover, the first loudspeaker 17A is used to playback the first channel audio signal; the second loudspeaker 17B is used to playback the second channel audio signal; and the third loudspeaker 17C is used to playback the third channel audio signal.

As shown in FIG. 1B, the above mentioned multi-channel audio system can further include an integration device 18. In this embodiment, the input signals of the transmission end 10A are the first channel audio signal, the second channel audio signal, and the third channel audio signal. And, the integration device 18 is used to receive these three channels of audio signals, to integrate them into an integrated audio signal, and then to transmit the integrated audio signal to the transmitter 11.

From the above mentioned examples, it is noted that, according to the prior art, each of the playback apparatus must include a decoder (e.g., a 5.1 channel Dolby decoder) to decode the corresponding channel of audio signals in the multi-channel audio system. Therefore, the design with several decoders causes high cost of the reception end and a complex circuit.

### SUMMARY OF THE INVENTION

In order to solve the problems mentioned above, the present invention provides a wireless multi-channel audio system. The audio system, according to the invention, mixes a plurality of channels of audio signals to generate a mixed signal in a time-division multiplexing way. Then, the only thing the receiver of each playback apparatus has to do is to receive the corresponding channel of audio signals from the mixed signals; namely, they do not need to decode an integrated audio signal first. As a result, the wireless multi-channel audio system according the invention requires no decoders.

A preferred embodiment according to the invention is an audio system. The audio system includes a multiplexer, a transmitting antenna, a transmitter, and M playback apparatus. M is a positive integer.

The multiplexer is used to receive M channels of audio signals, wherein M is a positive integer. After adding an ith identification to the ith channel of audio signals among the M channels of audio signals, the multiplexer mixes the M channels of audio signals to generate a mixed signal in a time-division multiplexing way, wherein i is an integer index ranging from 1 to M. And, the transmitter is respectively coupled to the multiplexer and the transmitting antenna. After receiving the mixed signal from the multiplexer, the transmitter transmits the mixed signal via the transmitting antenna.

The ith playback apparatus among the M playback apparatuses includes an ith antenna, an ith receiver, and an ith loudspeaker. The ith receiver receives the ith channel of audio signals from the mixed signal according to the ith identification via the ith antenna. And, the ith loudspeaker is coupled to the ith receiver and plays back the ith channel of audio signal received by the ith receiver.

The advantage and spirit of the invention may be understood by the following recitations together with the appended drawings.

### BRIEF DESCRIPTION OF THE APPENDED DRAWINGS

FIG. 1A and FIG. 1B show a multi-channel audio system according to the prior art.

FIG. 2 is a block diagram of the audio system according to the first preferred embodiment of the invention.

FIG. 3 shows an example of the mixed signal according to the invention.

FIG. 4 is a block diagram of the audio system 20 further including three front loudspeakers.

FIG. 5 is a block diagram of the audio system 20 further including three amplifiers.

FIG. 6 is a block diagram of the audio system according to the second preferred embodiment of the invention.

FIG. 7 is a block diagram of the audio system according to the third preferred embodiment of the invention.

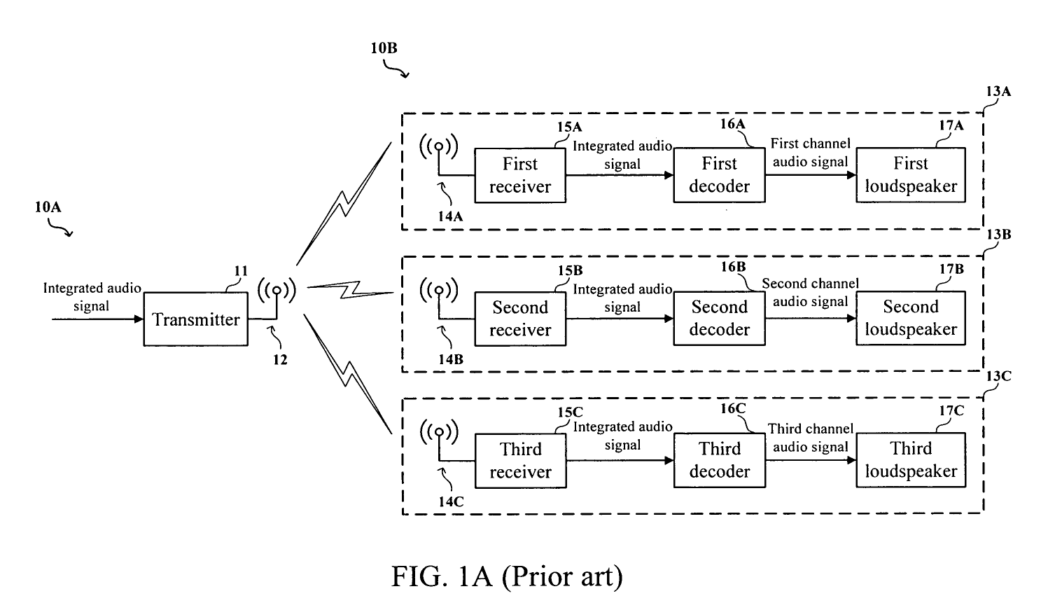

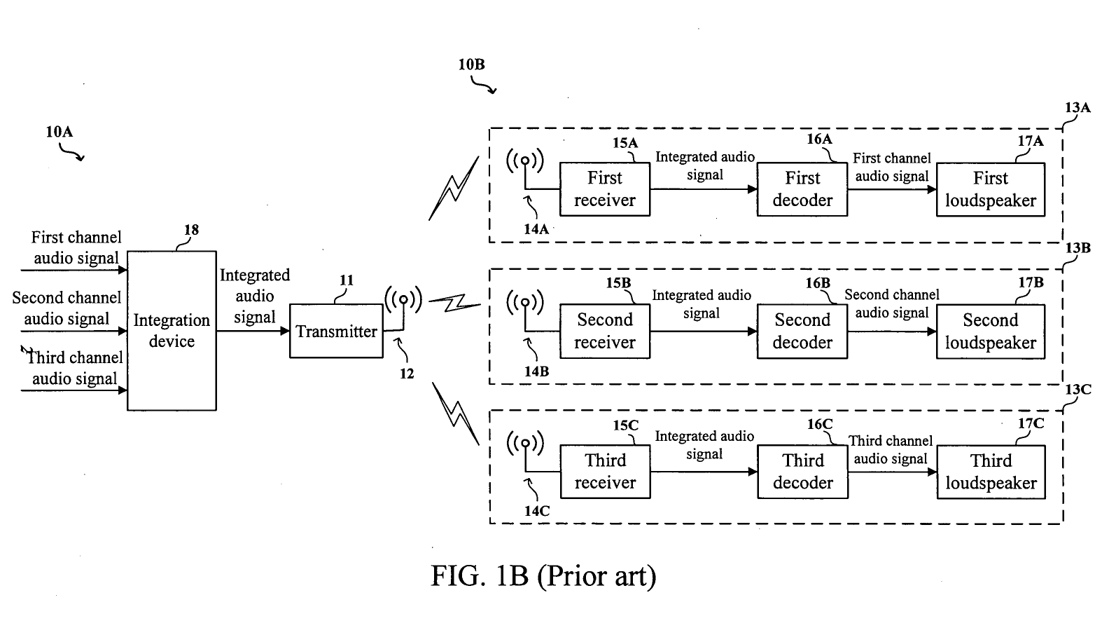

### DETAILED DESCRIPTION OF THE INVENTION

The invention provides a wireless multi-channel audio system. The audio system according to the invention mixes a plurality of channels of audio signals to generate a mixed signal in a time-division multiplexing way. Thus, the wireless receiver of each playback apparatus only needs to receive the corresponding channel of audio signals from the mixed signal; namely, they do not need to decode an integrated audio signal first as that in the prior art. By doing so, the wireless multi-channel audio system according the invention requires no decoders.

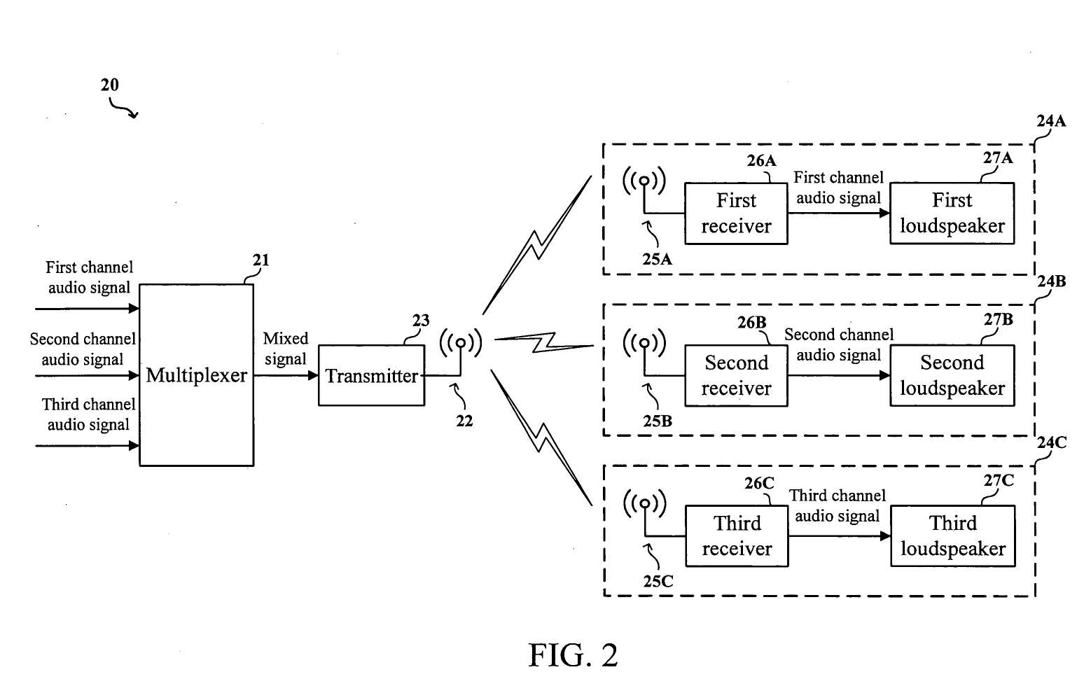

The first preferred embodiment according to the invention is an audio system. Referring to FIG. 2, FIG. 2 is a block diagram of the audio system. And, the audio system 20 includes a multiplexer 21, a transmitting antenna 22, a transmitter 23, and M playback apparatus. In order to easily demonstrate this embodiment, it is assumed that M equals to 3. In practical applications, M can be other integers. The M playback apparatuses refer to the first playback apparatus 24A, the second playback apparatus 24B, and the third playback apparatus 24C.

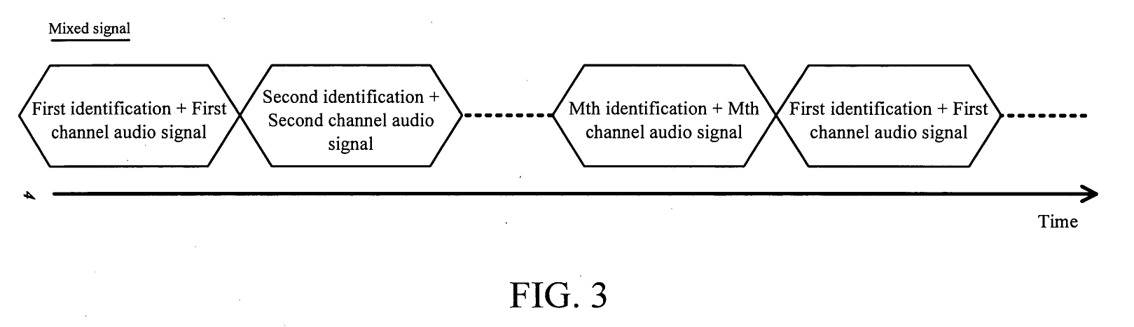

The multiplexer 21 is used to receive M channels of audio signals (the first channel audio signal, the second channel audio signal, and the third channel audio signal shown in FIG. 2) and add an ith identification to the ith channel of audio signals among the M channels of audio signals. i is an integer index ranging from 1 to M. More specifically, the multiplexer 21 adds the first identification to the first channel audio signal, the second identification to the second channel audio signal, and the third identification to the third channel audio signal respectively. Then, the multiplexer 21 mixes the M channels of audio signals to generate a mixed signal in a time-division multiplexing way. Referring to FIG. 3, FIG. 3 shows an example of the mixed signal.

The transmitter 23 is respectively coupled to the multiplexer 21 and the transmitting antenna 22. After receiving the mixed signal from the multiplexer 21, the transmitter 23 transmits the mixed signal via the transmitting antenna 22.

As shown in FIG. 2, the first playback apparatus 24A includes the first antenna 25A, the first receiver 26A, and the first loudspeaker 27A; the second playback apparatus 24B includes the second antenna 25B, the second receiver 26B, and the second loudspeaker 27B; and the third playback apparatus 24C includes the third antenna 25C, the third receiver 26C, and the third loudspeaker 27C.

In the first playback apparatus 24A, the first receiver 26A receives the first channel of audio signals from the mixed signal according to the first identification via the ith antenna. More specifically, the first receiver 26A only needs to identify and receive the parts marked by the first identification; namely, it does not need to receive all data in the mixed signal or to decode the mixed signal. Then, the first loudspeaker 27A is used to play back the first channel of audio signals received by the first receiver 26A.

The operation mode of the second playback apparatus 24B and the third playback apparatus 24C is approximately the same as that of the first playback apparatus 24A. The difference among them is that the second playback apparatus 24B is used to receive and play back the second channel audio signal, but the third playback apparatus 24C is used to receive and play back the third channel audio signal.

In practical applications, the audio system 20 can further include N front loudspeakers, wherein N is a positive integer. The N front loudspeakers are used to receive and play back the N front audio signals relative to the M channels of audio signals. If M and N both equal to 3, the audio system 20 could be a 5.1-channel audio system.

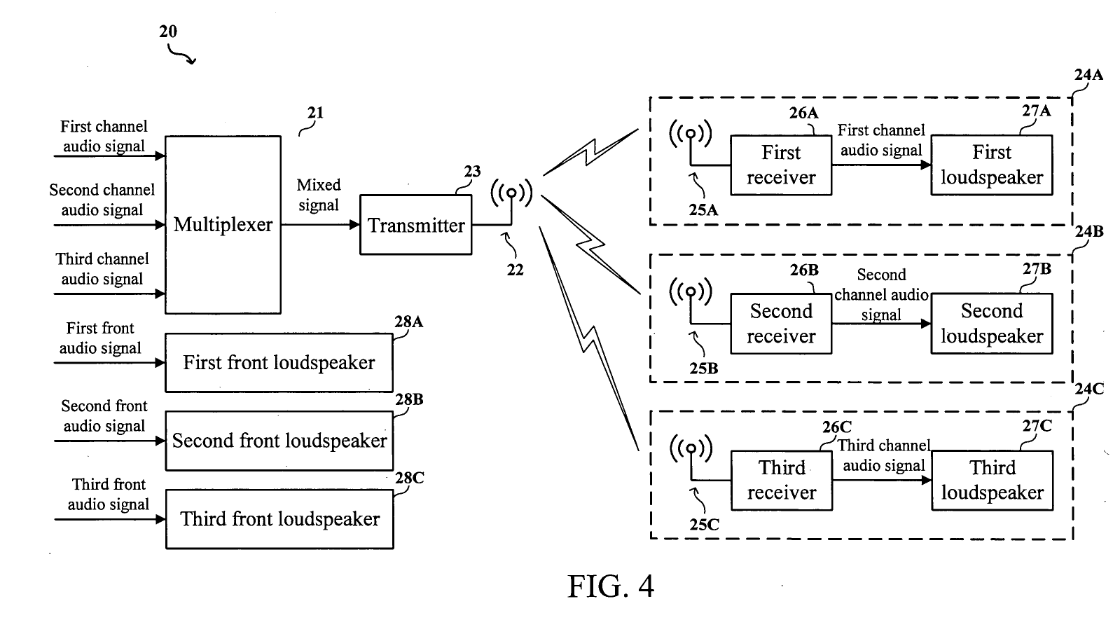

FIG. 4 is the block diagram of the audio system 20 which further includes three front loudspeakers. The first front loudspeaker 28A is used to receive and play back a first front audio signal; the second front loudspeaker 28B is used to receive and play back a second front audio signal; and the third front loudspeaker 28C is used to receive and play back a third front audio signal. In this example, the audio system 20 could be a 5.1-channel audio system. That is to say, the first loudspeaker 27A, the second loudspeaker 27B, and the third loudspeaker 27C can be a left rear loudspeaker, a bass loudspeaker, and a right rear loudspeaker, respectively. And, the first front loudspeaker 28A, the second front loudspeaker 28B, and the third front loudspeaker 28C can be a left loudspeaker, a middle loudspeaker, and a right loudspeaker.

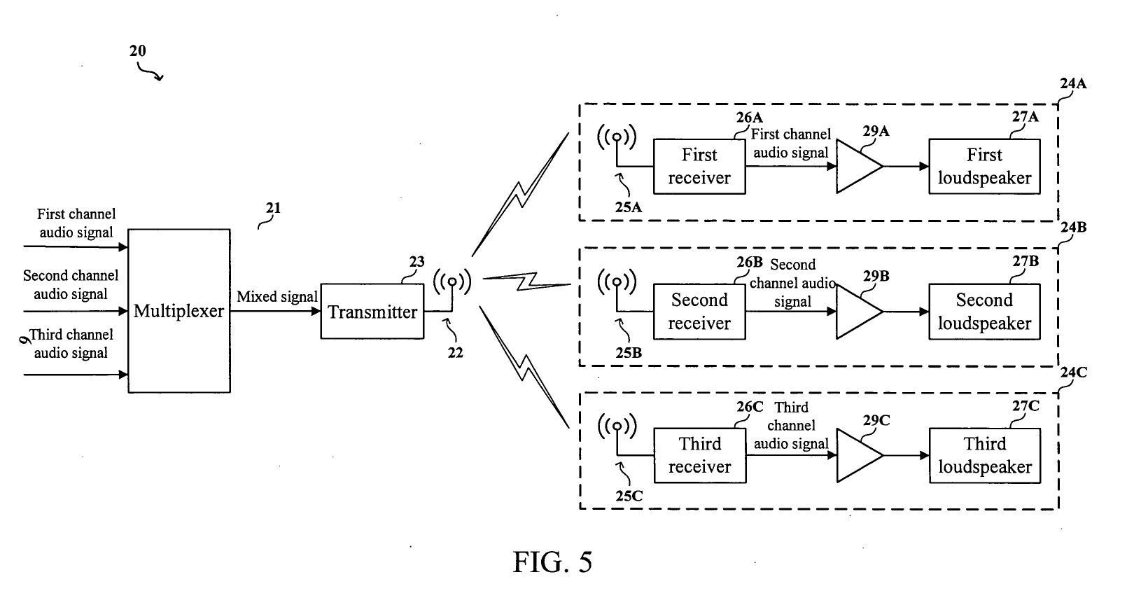

As shown in FIG. 5, in practical applications, the first playback apparatus 24A, the second playback apparatus 24B, and the third playback apparatus 24C can further include an amplifier respectively. The first amplifier 29A is used to amplify the first channel audio signal; the second amplifier 29B is used to amplify the second channel audio signal; and, the third amplifier 29C is used to amplify the third channel audio signal.

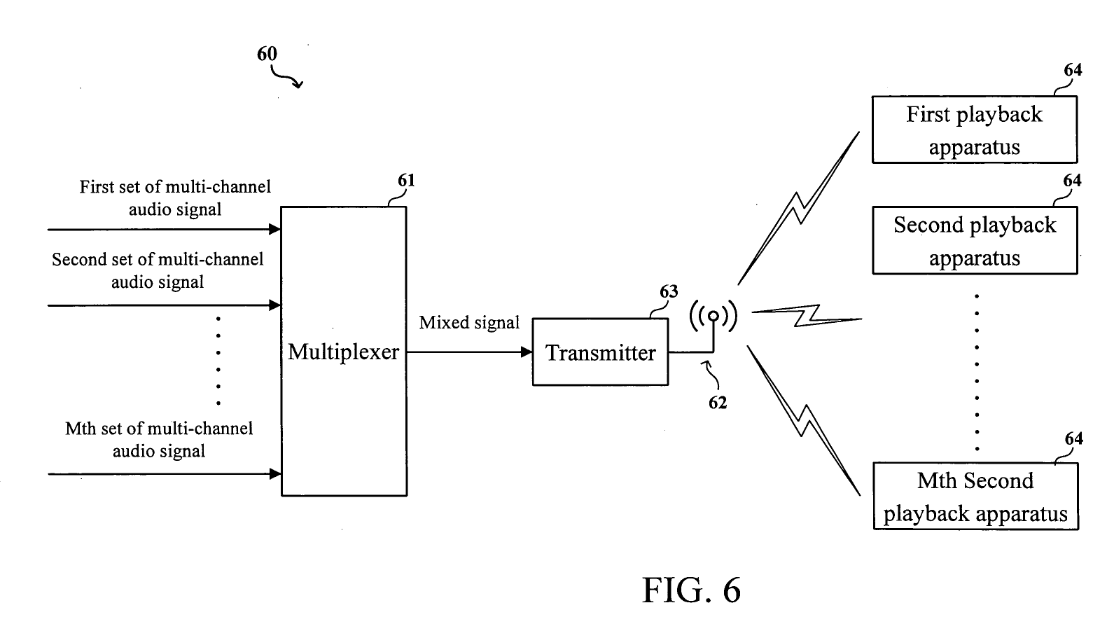

The second preferred embodiment according to the invention is also an audio system. Referring to FIG. 6, FIG. 6 is a block diagram of the audio system. The audio system 60 includes a multiplexer 61, a transmitting antenna 62, a transmitter 63, and M playback apparatus 64.

The multiplexer 61 is used to receive M channels of audio signals and add an ith identification to the ith channel of audio signals among the M channels of audio signals. i is an integer index ranging from 1 to M. Then, the multiplexer 61 mixes the M channels of audio signals to generate a mixed signal in a time-division multiplexing way.

Referring to FIG. 3, FIG. 3 shows an example of the mixed signal. The transmitter 63 is respectively coupled to the multiplexer 61 and the transmitting antenna 62. After receiving the mixed signal from the multiplexer 61, the transmitter 63 transmits the mixed signal via the transmitting antenna 62. And, the ith playback apparatus among the M playback apparatuses receives the ith set of multi-channel audio signals from the mixed signal according to the ith identification and plays back the ith set of multi-channel audio signals.

The main difference between the audio system 60 and audio system 20 is that the input signals of the audio system 60 are not a plurality of multi-channel audio signals but sets of plurality of multi-channel audio signals.

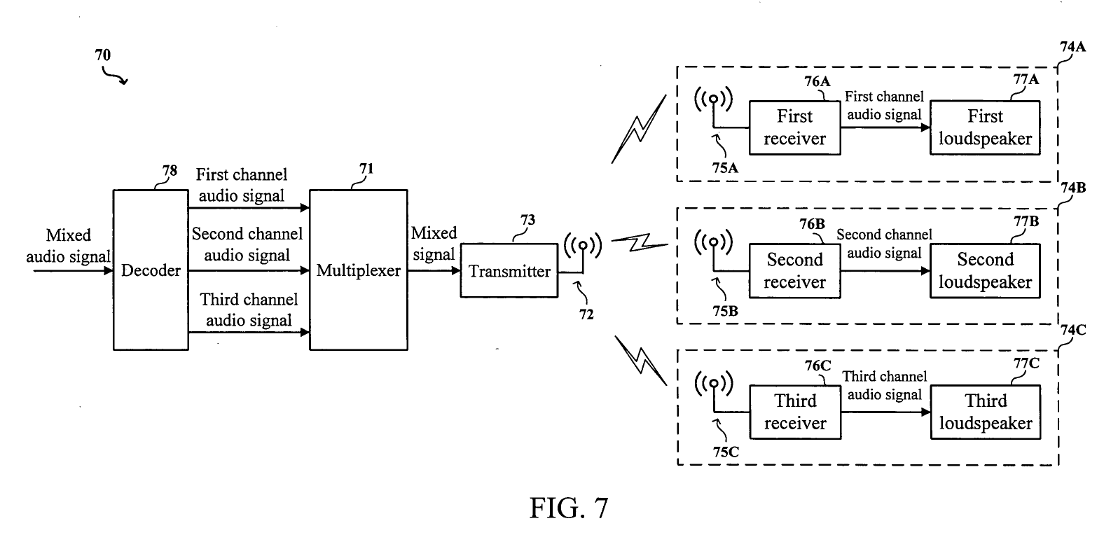

The third preferred embodiment according to the invention is also an audio system. Referring to FIG. 7, FIG. 7 is a block diagram of the audio system. The inputted signal of the audio system 70 is an integrated audio signal. Thus, except a multiplexer 61, a transmitting antenna 62, a transmitter 63, and M playback apparatus, the audio system 70 further includes a decoder 78.

In this embodiment, it is assumed that M equals to 3. The M playback apparatuses refer to the first playback apparatus 74A, the second playback apparatus 74B, and the third playback apparatus 74C respectively. As shown in FIG. 7, the first playback apparatus 74A includes the first antenna 75A, the first receiver 76A, and the first loudspeaker 77A; the second playback apparatus 74B includes the second antenna 75B, the second receiver 76B, and the second loudspeaker 77B; and the third playback apparatus 74C includes the third antenna 75C, the third receiver 76C, and the third loudspeaker 77C.

The decoder 78 is used to receive and decode the integrated audio signal into M channels of audio signals (e.g. the first channel audio signal, the second channel audio signal, and the third channel audio signal shown in FIG. 7). The functions and operational modes of other blocks in the audio system 70 are similar to those in the audio system 20, so the details are not further described herein.

The audio system based on the invention does not need to decode integrated audio signals as done in the prior art. Thus, the hardware resource and cost required by the decoder can be saved; moreover, the circuit structure of the audio system will be simplified.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A wireless multi-channel audio system, comprising:
a multiplexer for receiving M channels of audio signals, M being a positive integer, after adding an ith identification to the ith channel of audio signals among the M channels of audio signals, the multiplexer mixing the M channels of audio signals to generate a mixed signal in a time-division multiplexing way, wherein i is an integer index ranging from 1 to M;
a transmitting antenna;
a transmitter respectively coupled to the multiplexer and the transmitting antenna, after receiving the mixed signal from the multiplexer, the transmitter transmitting the mixed signal via the transmitting antenna; and
M playback apparatuses, the ith playback apparatus among the M playback apparatuses comprising:
an ith antenna;
an ith receiver for receiving the ith channel of audio signals from the mixed signal according to the ith identification via the ith antenna; and
an ith loudspeaker coupled to the ith receiver and playing back the ith channel of audio signals received by the ith receiver.

2. The wireless multi-channel audio system of claim 1, wherein the M channels of audio signals comprise at least one audio signal in a 5.1 channel audio signal.

3. The wireless multi-channel audio system of claim 1, wherein the M loudspeakers in the M playback apparatuses comprise a left rear loudspeaker, a bass loudspeaker and a right rear loudspeaker.

4. The wireless multi-channel audio system of claim 1, the audio system further comprising:
N front loudspeakers for receiving and playing back N front audio signals relative to the M channels of audio signals, wherein N is a positive integer.

5. The wireless multi-channel audio system of claim 1, wherein the ith playback apparatus further comprises:
an ith amplifier, electrically connected between the ith receiver and the ith loudspeaker, for amplifying the ith channel of audio signals.

6. An wireless multi-channel audio system, comprising:
a multiplexer for receiving M sets of multi-channel audio signals, M being a positive integer, after adding an ith identification to the ith set of multi-channel audio signals among the M sets of multi-channel audio signals, the multiplexer mixing the M sets of multi-channel audio signals to generate a mixed signal in a time-division multiplexing way, wherein i is an integer index ranging from 1 to M;
a transmitting antenna;
a transmitter respectively coupled to the multiplexer and the transmitting antenna, after receiving the mixed signal from the multiplexer, the transmitter transmitting the mixed signal via the transmitting antenna; and
M playback apparatuses, the ith playback apparatus among the M playback apparatuses receiving the ith set of multi-channel audio signals from the mixed signal according to the ith identification and playing back the ith set of multi-channel audio signals.

7. An wireless multi-channel audio system, comprising:
a decoder for receiving and decoding an integrated audio signal into M channels of audio signals, wherein M is a positive integer;
a multiplexer, coupled to the decoder, for receiving the M channels of audio signals from the decoder, after adding an ith identification to the ith channel of audio signals among the M channels of audio signals, the multiplexer mixing the M channels of audio signals to generate a mixed signal in a time-division multiplexing way, wherein i is an integer index ranging from 1 to M;
a transmitting antenna;
a transmitter respectively coupled to the multiplexer and the transmitting antenna, after receiving the mixed signal from the multiplexer, the transmitter transmitting the mixed signal via the transmitting antenna; and
M playback apparatuses, the ith playback apparatus among the M playback apparatuses comprising:
an ith antenna;
an ith receiver for receiving the ith channel of audio signal from the mixed signal according to the ith identification via the ith antenna; and
an ith loudspeaker coupled to the ith receiver and playing back the ith channel of audio signals received by the ith receiver.

8. The wireless multi-channel audio system of claim 7, wherein the M channels of audio signals comprise at least one audio signal in a 5.1 channel audio signal.

9. The wireless multi-channel audio system of claim 7, wherein the M loudspeakers in the M playback apparatuses comprise a left rear loudspeaker, a bass loudspeaker and a right rear loudspeaker.

10. The wireless multi-channel audio system of claim 7, the audio system further comprising:
N front loudspeakers for receiving and playing back N front audio signals relative to the M channels of audio signals, wherein N is a positive integer.

11. The wireless multi-channel audio system of claim 7, wherein the ith playback apparatus further comprises:
an ith amplifier, electrically connected between the ith receiver and the ith loudspeaker, for amplifying the ith channel of audio signals.
